(19) United States
(12) Patent Application Publication
(10) Pub. No.: US 2015/0251223 A1
(43) Pub. Date: Sep. 10, 2015

(54) CLEANING MACHINE

(71) Applicant: HITACHI KOKI CO., LTD., Tokyo (JP)

(72) Inventors: Noriyuki Horie, Hitachinaka (JP); Shinichirou Satou, Hitachinaka (JP); Kazuhiko Funabashi, Hitachinaka (JP); Kenji Kobori, Hitachinaka (JP)

(21) Appl. No.: 14/419,460

(22) PCT Filed: Aug. 20, 2013
(86) PCT No.: PCT/JP2013/004903

§ 371 Date: Feb. 3, 2015

(30) Foreign Application Priority Data
Aug. 31, 2012 (JP) 2012-192312
Aug. 31, 2012 (JP) 2012-192361

(51) Int. Cl. B08B 3/02

(52) U.S. Cl. CPC B08B 3/026

(57) ABSTRACT

In a cleaning machine provided with a main body which discharges cleaning liquid by a pump and a cleaning gun which is connected to the main body, the cleaning machine has: an electric motor which receives electric power supply from a battery pack and which drives the pump; and a control circuit which changes a rotating speed of the electric motor so as to increase/decrease the discharging pressure of the cleaning liquid. When the voltage of the battery pack is decreased down to a predetermined second voltage higher than a predetermined first voltage at which the electric power supply to the electric motor is stopped, the largest discharging pressure of the cleaning liquid is decreased to be lower than a current-state discharging pressure thereof.

### TECHNICAL FIELD

The present invention relates to a cleaning machine.

### BACKGROUND ART

A cleaning machine has at least: a main body which is provided with an electric pump for pressurizing liquid; and a cleaning gun which is connected to the main body via a hose. The liquid pressurized by the electric pump is pumped to the cleaning gun via the hose, and is discharged from a spray nozzle provided at a tip of the cleaning gun toward a cleaning target (Patent Literature 1). Note that the liquid discharged from the cleaning machine is sometimes tap water or sometimes liquid containing cleanser or an abrasive agent or others. In the present specification, the liquid discharged from the cleaning machine will be collectively referred to as “cleaning liquid”.

### CITATION LIST

### Patent Literature

PTL 1: Japanese Patent Application Laid-Open Publication No. 2006-263628

### SUMMARY OF INVENTION

### Technical Problem

Conventionally, a commercial electric power source has been used as an electric power source of the cleaning machine, and a location of usage has been limited to where the commercial electric power source can be secured. However, if a battery is used as the electric power source of the cleaning machine, the cleaning machine can be used at locations where the commercial electric power source cannot be secured (such as outdoors, a balcony/porch, and a garage).

Meanwhile, a voltage of the battery (such as a manganese battery, a nickel-hydride battery, a nickel-cadmium battery, and a lithium battery) is rapidly decreased when a discharged capacity reaches a certain value. Further, in a case of a secondary battery, more particularly, a lithium battery, if the discharge is continued even after the voltage reaches a threshold voltage (if over discharge is caused), charge/discharge performance is significantly decreased.

Accordingly, many battery packs or others configured of a plurality of chargeable/dischargeable battery cells are provided with a circuit for preventing the over discharge. This type of the circuit monitors a voltage of each of the battery cells of the battery pack so as to stop the discharge if the voltage of at least one of the battery cells reaches a predetermined voltage (hereinafter, referred to as “discharge stopping voltage”).

In a case that the battery pack as described above is used as the electric power source of the cleaning machine, when the voltage of a certain battery cell reaches the discharge stopping voltage, electric power supply from the battery pack is interrupted so that operation of the cleaning machine stops. The discharge stopping voltage is generally set to be the same as or slightly higher than the threshold voltage of each of the battery cells. Therefore, while the voltage of the battery pack is gradually decreased until the discharged capacity reaches a certain value, the voltage is rapidly decreased when the discharged capacity reaches the certain value, and reaches the discharge stopping voltage in a short period of time. Therefore, it is difficult for an operator who is using the cleaning machine to recognize the voltage decrease of the battery pack. Also, even if the operator can recognize the voltage decrease of the battery pack, the recognition is made immediately before the voltage of the battery pack reaches the discharge stopping voltage. That is, there is a risk of a situation that, after the operator recognizes the voltage decrease of the battery pack, the operation of the cleaning machine stops in a short period of time.

Moreover, it is required to secure a space for housing the battery in order to use the battery as the electric power source, and therefore, there is a risk of increase in a size of the cleaning machine.

### Solution to Problem

In a cleaning machine provided with a main body which discharges cleaning liquid by a pump and a cleaning gun which is connected to the main body, the cleaning machine has: an electric motor which receives electric power supply from a battery to drive the pump; and a control part which increases/decreases a discharging pressure of the cleaning liquid by changing a rotating speed of the electric motor. When the voltage of the battery is decreased down to a predetermined second voltage higher than a predetermined first voltage at which the electric power supply to the electric motor is stopped, the largest discharging pressure of the cleaning liquid is decreased down to a pressure lower than a current-state discharging pressure thereof.

In a cleaning machine provided with a main body which discharges cleaning liquid by a pump and a cleaning gun which is connected to the main body, the cleaning machine has: an electric motor which receives electric power supply from a battery to drive the pump; and a control part which controls the electric motor, and the electric motor is driven in at least two control modes including a normal mode in which the cleaning liquid is discharged by a predetermined discharging pressure and an electricity saving mode in which the discharging pressure of the cleaning liquid is changed based on the voltage of the battery.

In a cleaning machine provided with a main body which discharges cleaning liquid by a pump and a cleaning gun which is connected to the main body, the cleaning machine has: an electric motor which receives electric power supply from a battery to drive the pump; and a control part which controls the electric motor, and the cleaning liquid can be discharged in at least two control modes including a high-pressure mode in which the cleaning liquid can be discharged by a first largest discharging pressure and a low-pressure mode in which the cleaning liquid can be discharged by a second largest discharging pressure lower than the first largest discharging pressure.

In a cleaning machine which discharges cleaning liquid, the cleaning machine has: a tank part which stores the cleaning liquid; a cleaning gun which sprays the cleaning liquid; and a drive part which is positioned below the tank part and which feeds the cleaning liquid to the cleaning gun while using a battery as an electric power source, and the battery is arranged above the drive part.

A cleaning machine has: a main body provided with a tank which stores cleaning liquid, a pump which feeds the cleaning liquid supplied from the tank, an electric motor which drives the pump, and a battery housing part which houses a battery serving as an electric power source of the electric motor; and a cleaning gun which sprays the cleaning liquid supplied from the main body, the pump and the electric motor are arranged in a lower part of the main body, the tank is arranged in an upper part of the main body, and the battery housing part is arranged among the pump, the electric motor, and the tank.

A cleaning machine has: a main body provided with a tank which stores cleaning liquid, a pump which feeds the cleaning liquid supplied from the tank, an electric motor which drives the pump, and a battery housing part which houses a battery serving as an electric power source of the electric motor; and a cleaning gun which sprays the cleaning liquid supplied from the main body, the pump and the electric motor are arranged in a lower part of the main body, the tank is arranged in an upper part of the main body, the tank is arranged in a upper part of the main body, the tank is provided with a concave part which is concaved toward inside of the tank, and the battery housing part is provided inside the concave part.

### Advantageous Effects of Invention

According to an aspect of the present invention, the continuous operation time of the cleaning machine using the battery as the electric power source can be extended. According to another aspect of the present invention, the limitation on the location of usage of the cleaning machine is reduced while avoiding the increase in the size of the cleaning machine.

### BRIEF DESCRIPTION OF DRAWINGS

FIG. 1 is a perspective view of a main body of a cleaning machine to which the present invention is applied;

FIG. 2 is a side view of a cleaning gun provided at the cleaning machine illustrated in FIG. 1;

FIG. 3 is a vertical (longitudinal) cross-sectional view of the main body illustrated in FIG. 1;

FIG. 4 is another vertical cross-sectional view of the main body illustrated in FIG. 1;

FIG. 5 is a control block diagram of the cleaning machine illustrated in FIG. 1;

FIG. 6 is a chart illustrating an example of a control flow of the cleaning machine illustrated in FIG. 1;

FIG. 7 is a diagram illustrating relations among a discharging pressure, a voltage, a current, and operating time;

FIG. 8 is another control block diagram of the cleaning machine illustrated in FIG. 1;

FIG. 9 is still another control block diagram of the cleaning machine illustrated in FIG. 1;

FIG. 10 is still another control block diagram of the cleaning machine illustrated in FIG. 1;

FIG. 11 is a chart illustrating another example of a control flow of the cleaning machine illustrated in FIG. 1;

FIG. 12 is a perspective view illustrating a main body of another cleaning machine to which the present invention is applied;

FIG. 13 is a side view of the main body of the cleaning machine illustrated in FIG. 12;

FIG. 14 is a front view of the main body of the cleaning machine illustrated in FIG. 12;

FIG. 15 is a side view of a cleaning gun provided at the cleaning machine illustrated in FIG. 12;

FIG. 16 is a vertical cross-sectional view of the main body taken along a line B-B illustrated in FIG. 14;

FIG. 17 is a lateral cross-sectional view of the main body taken along a line A-A illustrated in FIG. 13;

FIG. 18 is a perspective view of a tank;

FIG. 19 is another vertical cross-sectional view of the main body;

FIG. 20 is a vertical cross-sectional view illustrating a modification example of the cleaning machine to which the present invention is applied;

FIG. 21 is a vertical cross-sectional view illustrating another modification example of the cleaning machine to which the present invention is applied; and

FIG. 22 is a vertical cross-sectional view illustrating still another modification example of the cleaning machine to which the present invention is applied.

### DESCRIPTION OF EMBODIMENTS

### First Embodiment

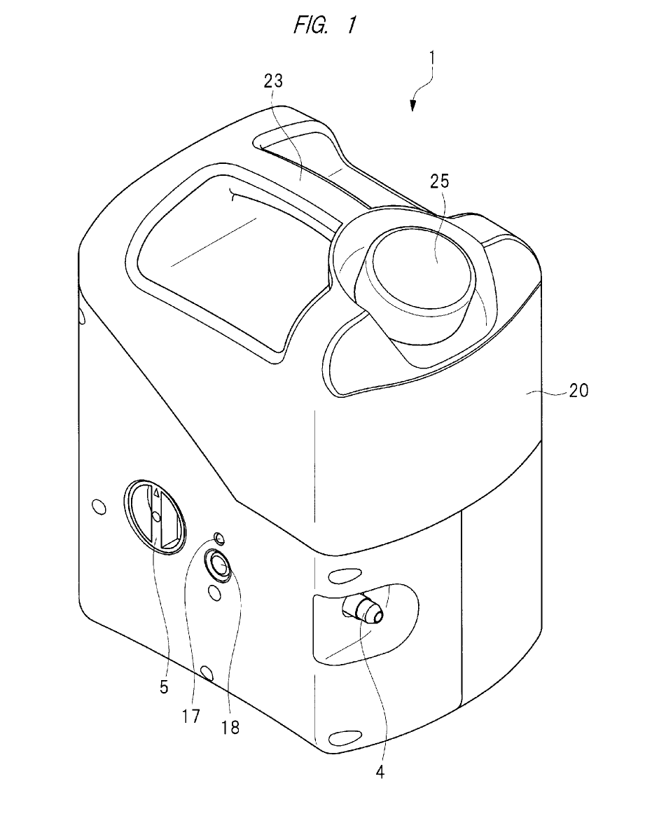

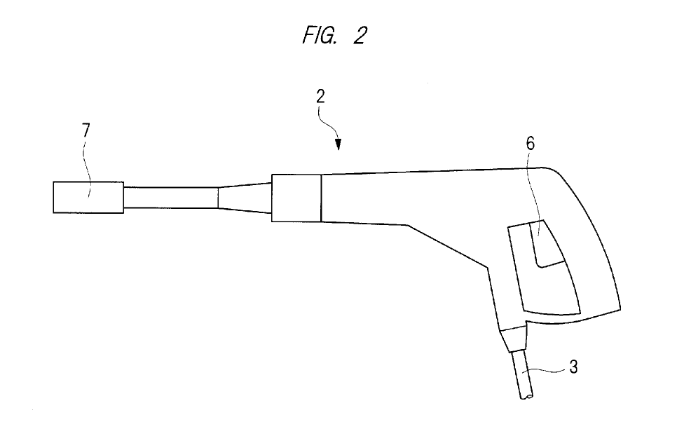

Hereinafter, a first embodiment of a cleaning machine to which the present invention is applied will be explained in detail with reference to drawings. The cleaning machine according to the present embodiment has: a main body 1 illustrated in FIG. 1; and a cleaning gun 2 illustrated in FIG. 2, and the main body 1 and the cleaning gun 2 are connected to each other via a hose 3.

As illustrated in FIG. 1, a tank 20 is integrally provided with an upper part of the main body 1, and a handle 23 and a flow inlet (feed-water inlet) for supplying cleaning liquid into the tank 20 are integrally molded with each other on an upper surface of the tank 20. When the cleaning liquid is supplied from the feed-water inlet into the tank 20 or when the cleaning liquid inside the tank 20 is discharged from the feed-water inlet, an illustrated cap 25 is removed from the main body 1 to open the feed-water inlet. The illustrated cap 25 is a screw-in type, and the cap 25 is rotated counterclockwise so as to be removed from the main body 1, and is rotated clockwise so as to be fixed to the main body 1.

On a side surface of the main body 1, a main switch 5 serving as an operating part is provided. The main switch 5 is a dial type, and the electric power source of the cleaning machine is turned ON/OFF by a rotating operation of the main switch 5. In the present embodiment, the electric power source is turned ON by rotating the main switch 5 clockwise by a predetermined angle from an initial position, and the electric power source is turned OFF by rotating the main switch 5 counterclockwise to be returned to the initial position.

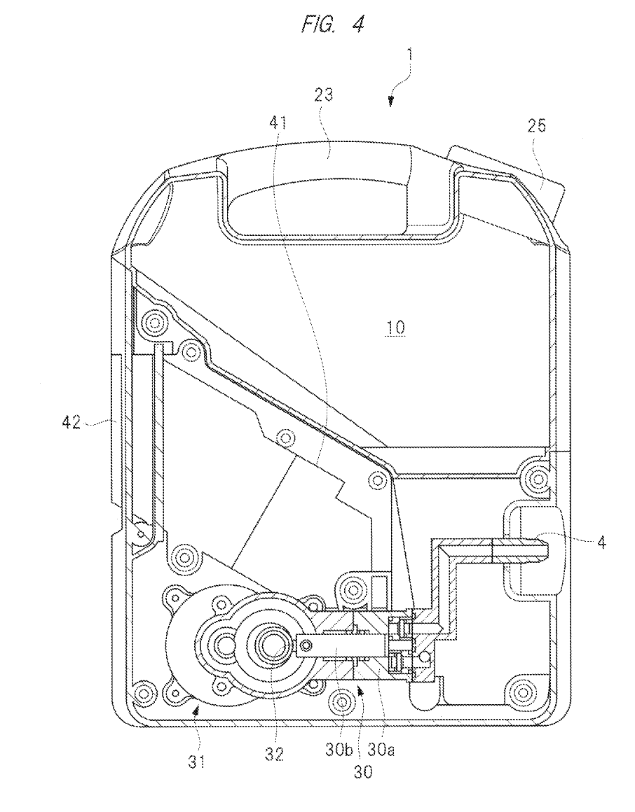

On a front surface of the main body 1, a connection plug 4 to which a hose 3 extended from the cleaning gun 2 illustrated in FIG. 2 is to be connected is provided. By performing the rotating operation of the main switch 5 as described above, a pump 30 (FIG. 4) is driven by an electric motor 31 (FIG. 4) described later, so that the pressurized cleaning liquid is supplied (pumped) to the cleaning gun 2 via the hose 3. When a trigger lever 6 of the cleaning gun 2 is operated (pulled) in this state, the cleaning liquid is discharged from a spray nozzle 7 which is provided at a tip of the cleaning gun 2. Further, after the electric power source of the cleaning machine is turned ON, the rotating speed of the electric motor 31 illustrated in FIG. 4 is increased/decreased in accordance with a degree of the operation (a rotation angle with respect to the initial position) of the main switch 5. More specifically, the rotating speed of the electric motor 31 is increased by the increase in the rotation angle of the main switch 5, and the rotating speed of the electric motor 31 is decreased by the decrease in the rotation angle. That is, the main switch 5 functions as the operating part which changes the rotating speed of the electric motor 31 to increase/decrease the discharging pressure of the cleaning liquid.

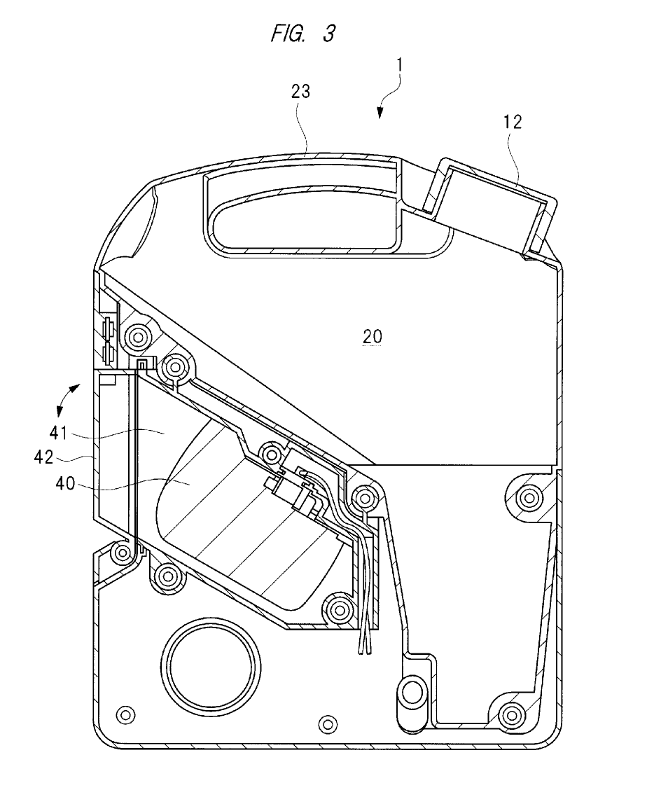

As illustrated in FIG. 3, a battery housing part 41 is formed in the lower part of the main body 1 (below the tank 20), and a battery 40 serving as the electric power source is housed in the battery housing part 41. On a back surface of the main body 1, a cover member 42 which opens/closes the battery housing part 41 is provided to be rotatable in a direction indicated by an arrow in the drawing. The battery housing part 41 is opened by rotating the cover member 42, so that the battery 40 can be housed in the battery housing part 41, or the housed battery 40 can be removed from the battery housing part 41. An electrode (main-body-side electrode) is provided on an inner wall of the battery housing part 41. When the battery 40 is housed in the battery housing part 41, an electrode (battery-side electrode) provided on the battery 40 is in contact with the main-body-side electrode, so that electrical conduction is ensured.

The battery 40 in the present embodiment is a battery pack (secondary battery (lithium-ion battery)) configured of four serially-connected battery cells, and has a nominal voltage of 14.4 [V]. Also, the battery pack 40 is provided with an over-discharge preventing circuit in which discharge is stopped when the voltage is decreased down to a predetermined first voltage (hereinafter, referred to as “discharge stopping voltage”). In the present embodiment, the discharge stopping voltage is set to 8.0 [V] (2.0 V per the battery cell). When the voltage of the battery pack 21 becomes 8.0 [V], discharge of the battery pack 40 is stopped by the over-discharge preventing circuit. That is, electric power supply from the battery pack 40 is interrupted.

As illustrated in FIG. 4, in the lower part of the main body 1 (below the battery housing part 41), the pump 30 which pressurizes the cleaning liquid supplied from the tank 20, the electric motor 31 which receives electric power supply from the battery pack 40 (FIG. 3) to drive the pump 30, and a circuit board on which various circuits are provided are arranged.

The pump 30 has a cylinder 30a and a plunger 30b which is housed inside the cylinder 30a so as to be reciprocated, and the rotary motion of the electric motor 31 is converted into the reciprocating motion by a crankshaft 32 and is transmitted to the plunger 30b. That is, the pump 30 is an electric pump which is driven by the electric motor 31.

The cylinder 30a of the pump 30 is provided with a flow inlet into which the cleaning liquid is flowed and a flow outlet from which the cleaning liquid is flowed out, and each of the flow inlet and the flow outlet is provided with a one-way valve. Also, inside the main body 1, a flow channel for guiding the cleaning liquid which is supplied from the tank 20 to the flow inlet of the cylinder 30a and a flow channel for guiding the cleaning liquid which is flowed out from the flow outlet of the cylinder 30a to the connection plug 4 are provided. The cleaning liquid which has been flowed from the flow inlet into the cylinder 30a is compressed (pressurized) by the plunger 30b which repeats the reciprocating motion inside the cylinder 30a. The pressurized cleaning liquid is flowed out from the flow outlet of the cylinder 30a, and is fed to the connection plug 4 through the above-described flow channels. The cleaning liquid which has been fed to the connection plug 4 is fed to the cleaning gun 2 (FIG. 2) via the hose 3 (FIG. 2) connected to the connection plug 4.

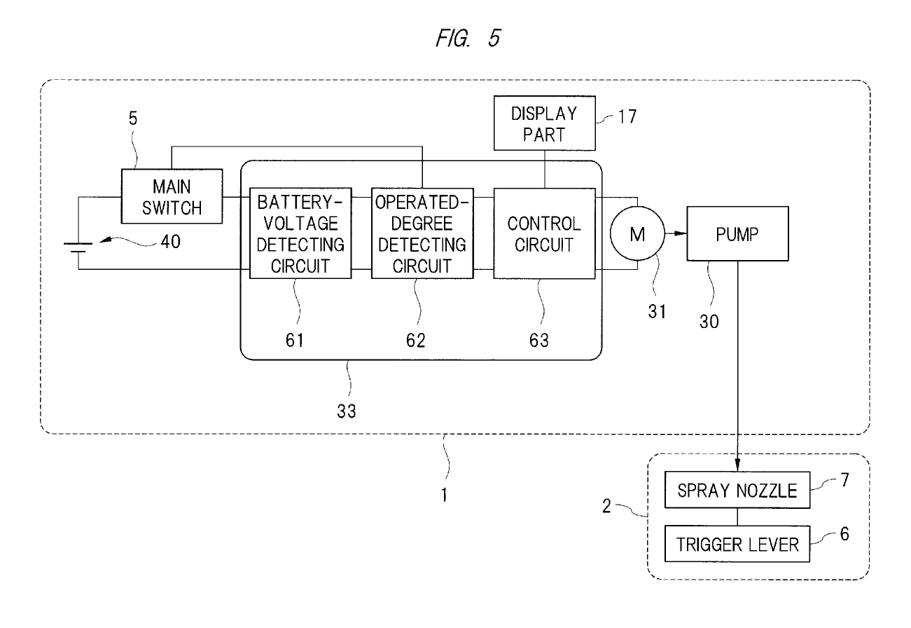

As illustrated in FIG. 5, the circuit board is provided with at least a battery-voltage detecting circuit 61, an operated-degree detecting circuit 62, and a control circuit 63 which configures a control part. The battery-voltage detecting circuit 61 detects the voltage of the battery pack 40 and outputs a detection result to the control circuit 63. The operated-degree detecting circuit 62 detects the rotation angle of the main switch 5 and outputs a detection result to the control circuit 63. The control circuit 63 controls the electric motor 31 based on detection results of the battery-voltage detecting circuit 61 and the operated-degree detecting circuit 62.

First, the control of the electric motor 31 based on the detection result of the operated-degree detecting circuit 62 will be explained. The operated-degree detecting circuit 62 outputs a signal in accordance with the rotation angle of the main switch 5. The control circuit 63 changes the rotating speed of the electric motor 31 based on the signal outputted from the operated-degree detecting circuit 62 so as to continuously increases/decreases the discharging pressure of the cleaning liquid. Here, the discharging pressure of the cleaning liquid means a pressure of the cleaning liquid at an outlet of the pump 30 (the flow outlet of the cylinder 30a illustrated in FIG. 4).

Further, the control circuit 63 controls the rotating speed of the electric motor 31 in accordance with at least two control modes including the normal mode and the electricity saving mode. The largest discharging pressure of the cleaning liquid is previously set for each of the control modes, and the largest discharging pressure of the electricity saving mode is set to be lower than the largest discharging pressure of the normal mode. As described above, the control circuit 63 increases/decreases the discharging pressure of the cleaning liquid in accordance with the increase/decrease in the rotation angle of the main switch 5, and the discharging pressure is increased/decreased within a range equal to or lower than the largest discharging pressure of the control mode at that time. That is, the discharging pressure obtained when the rotation angle of the main switch 5 in the normal mode is the largest is different from the discharging pressure obtained when the rotation angle of the main switch 5 in the electricity saving mode is the largest, and the latter is lower than the former. In the present embodiment, the largest discharging pressure in the normal mode is set to 8.0 [MPa], and the largest discharging pressure in the electricity saving mode is set to 5.0 [MPa]. Also, in the normal mode, the largest rotating speed of the electric motor 31 is 16,000 [min⁻¹], and the largest consumed current is 30 [A]. On the other hand, in the electricity saving mode, the largest rotating speed of the electric motor 31 is 10,000 [min⁻¹], and the largest consumed current is 15 [A].

Note that the discharging pressure of the cleaning liquid depends on the rotating speed of the electric motor 31, and that the rotating speed of the electric motor 31 depends on an applied voltage. Therefore, the largest discharging pressure in each of the control modes is set as the largest applied voltage to the electric motor 31. The control circuit 63 increases/decreases the rotating speed of the electric motor 31 by changing the applied voltage to the electric motor 31, so that the discharging pressure of the cleaning liquid is increased/decreased.

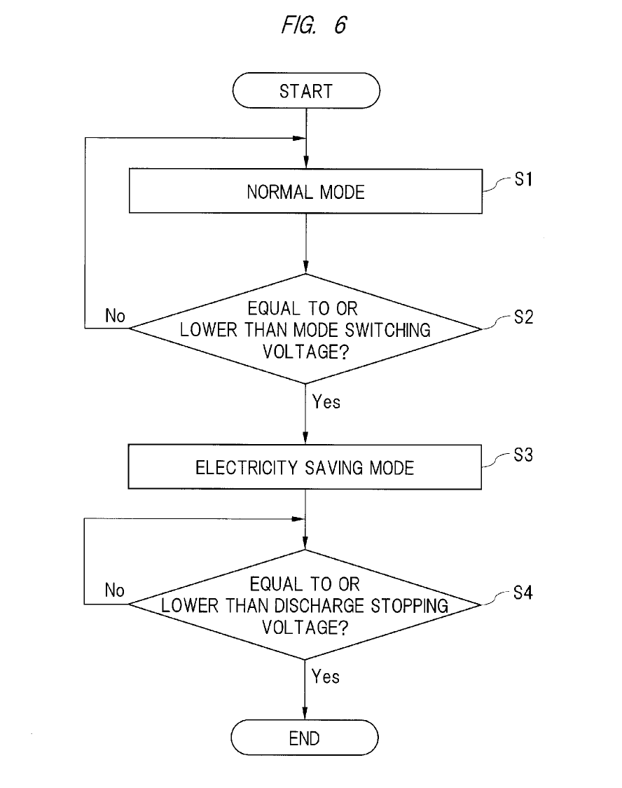

Next, the control of the electric motor 31 based on the detection result of the battery-voltage detecting circuit 61 will be explained. When the electric power source is turned ON by operating the main switch 5, the control circuit 63 controls the electric motor 31 in the normal mode which is an initially-set control mode (at a step S1 of FIG. 6).

Then, the control circuit 63 monitors the voltage of the battery pack 40 based on the detection result of the battery-voltage detecting circuit 61 (at a step S2 of FIG. 6). The battery-voltage detecting circuit 61 outputs a signal when the voltage of the battery pack 40 is decreased down to a predetermined second voltage. More specifically, the battery-voltage detecting circuit 61 compares the voltage of the battery pack 40 with the second voltage (hereinafter, referred to as “mode switching voltage”) serving as a reference voltage, and outputs the signal when the voltage of the battery pack 40 is decreased down to the mode switching voltage or lower. Accordingly, if the signal outputted from the battery-voltage detecting circuit 61 is inputted to the control circuit 63 while the control circuit 63 is controlling the electric motor 31 in the normal mode, the control circuit 63 determines that the voltage of the battery pack 40 has been decreased down to the mode switching voltage, and switches the control mode from the normal mode to the electricity saving mode (at a step S3 of FIG. 6). Here, the mode switching voltage is a voltage which is lower than the nominal voltage (14.4 V) of the battery pack 40 and which is higher than the discharge stopping voltage (8.0 V), and is set to 10.0 [V] in the present embodiment. That is, before the voltage of the battery pack 40 is decreased down to the discharge stopping voltage, the control mode of the electric motor 31 is automatically switched from the normal mode to the electricity saving mode. In other words, before the voltage of the battery pack 40 reaches the discharge stopping voltage, the largest discharging pressure of the cleaning liquid is automatically limited. Then, when the voltage of the battery pack 40 is further decreased and reaches the discharge stopping voltage, the discharge of the battery pack 40 is stopped by the over-discharge preventing circuit, and the operation of the cleaning machine stops (at a step S4 of FIG. 6).

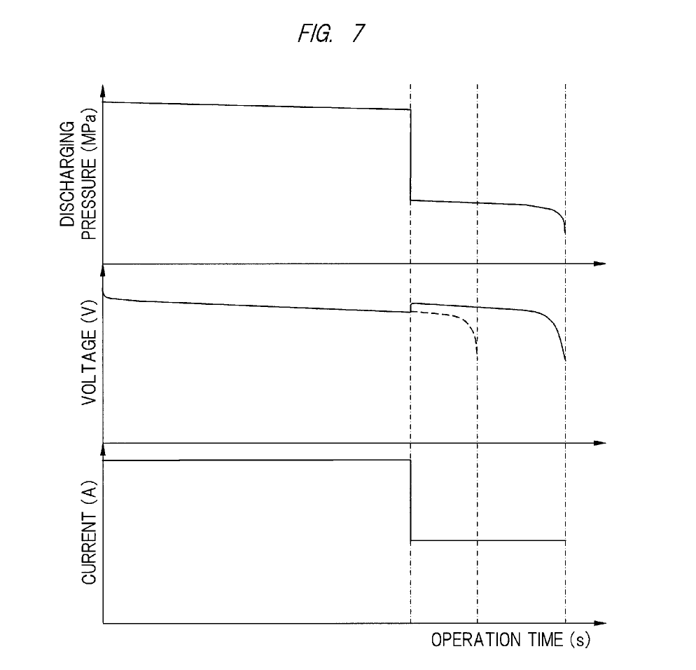

As described above, when the voltage of the battery pack 40 reaches the discharge stopping voltage, the discharge of the battery pack 40 is stopped by the over-discharge preventing circuit. Therefore, the continuous operation time of the cleaning machine is the time taken from the beginning of use until the voltage of the battery pack 40 reaches the discharge stopping voltage. Regarding this point, in the cleaning machine according to the present embodiment, the mode switching is automatically executed before the voltage of the battery pack 40 reaches the discharge stopping voltage so that the largest discharging pressure of the cleaning liquid is limited. That is, the highest rotating speed of the electric motor 31 is limited. In other words, the largest applied voltage to the electric motor 31 is limited, and therefore, the consumed electric power of the battery pack 40 is limited. Therefore, as illustrated in FIG. 7, although the largest discharging pressure is decreased whereas the time taken from the beginning of use until the voltage of the battery pack 40 reaches the discharge stopping voltage is extended, and the continuous operation time of the cleaning machine is extended totally.

As illustrated in FIG. 5, the cleaning machine according to the present embodiment is provided with a display part 17. The control circuit 63 switches the control mode of the electric motor 31 from the normal mode to the electricity saving mode as described above, and, at the same time, operates the display part 17 to inform the operator of the voltage decrease of the battery pack 40. The display part 17 in the present embodiment is a LED 17 (FIG. 1) provided on the side surface of the main body 1, and the control circuit 63 lights the LED 17 at the same time as the switching of the control mode. Note that the operator may be informed of the voltage decrease by changing a lighting color of the LED 17 for each of the normal mode and the electricity saving mode. For example, the LED 17 may be lit with a green color in the normal mode, and with a red color in the electricity saving mode. Further, a liquid crystal monitor may be provided as the display part 17 to display a predetermined message for informing the voltage decrease on the monitor.

As a matter of course, in the present embodiment, the largest discharging pressure in the normal mode is set to 8.0 [MPa] whereas the largest discharging pressure in the electricity saving mode is set to 5.0 [MPa]. Therefore, when the control mode is switched from the normal mode to the electricity saving mode, the discharging pressure of the cleaning liquid is decreased by a downward difference that is sufficiently recognized by the operator. Therefore, the operator can recognize the voltage decrease of the battery pack 40 because of the decrease in the discharging pressure of the cleaning liquid, and therefore, the display part 17 may be eliminated. Here, the largest discharging pressure in each the control modes is not limited to the above-described pressure, but can be appropriately set. However, from a viewpoint of informing the operator of the voltage decrease by the decrease in the discharging pressure of the cleaning liquid, it is preferred that the largest discharging pressure in the electricity saving mode is set at 80% of the largest discharging pressure in the normal mode or lower.

Note that a push button 18 below the LED 17 illustrated in FIG. 1 is a dedicated button for causing the cleaning machine to execute a water drainage operation. Also, the largest discharging pressure (5.0 [MPa]) in the electricity saving mode is a sufficiently-large discharging pressure for a high-pressure cleaning operation.

Hereinafter, another embodiment of a cleaning machine to which the present invention is applied will be explained. As a matter of course, a basic configurations of a cleaning machine explained below is common to that of the cleaning machine according to the present embodiment. Accordingly, the explanation for the common configuration to the cleaning machine according to the present embodiment will be appropriately omitted, and different points will be mainly explained. Also, the same reference symbol is used for the common configuration to that of the cleaning machine according to the present embodiment.

### Second Embodiment

In the cleaning machine according to the first embodiment, the operating part for increasing/decreasing the discharging pressure of the cleaning liquid by changing the rotating speed of the electric motor 31 is the main switch 5 provided on the main body 1. On the other hand, in a cleaning machine according to the present embodiment, the above-described operating part is provided on the cleaning gun 2.

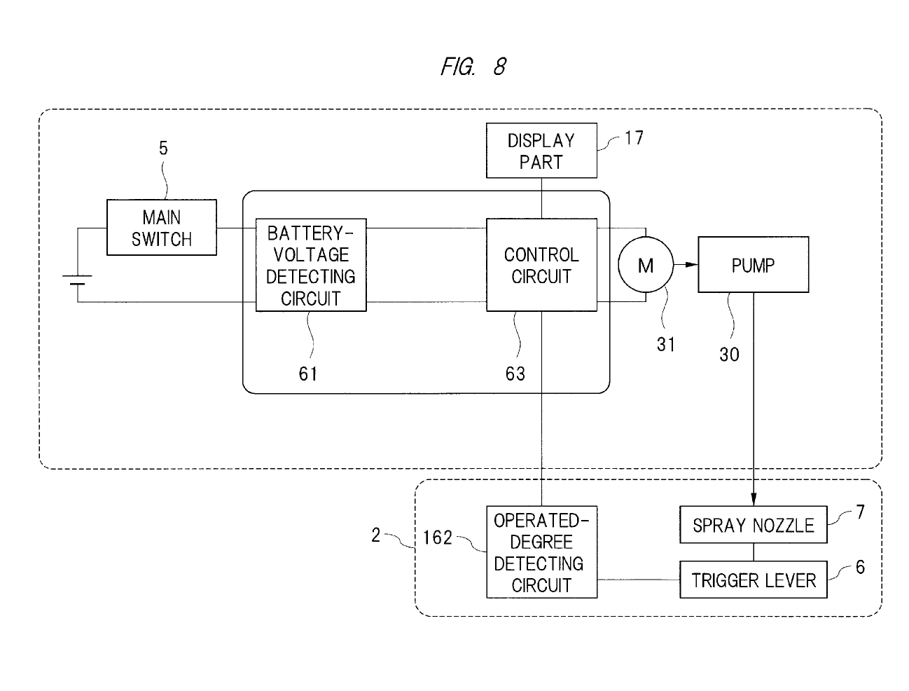

As illustrated in FIG. 8, the cleaning gun 2 provided in the cleaning machine according to the present embodiment is provided with an operated-degree detecting circuit 162 corresponding to the operated-degree detecting circuit 62 illustrated in FIG. 5. The operated-degree detecting circuit 162 outputs a signal corresponding to the operated degree (a stroke amount) of the trigger lever 6 provided in the cleaning gun 2. The control circuit 63 changes the rotating speed of the electric motor 31 based on a signal outputted from the operated-degree detecting circuit 162 so as to increase/decrease the discharging pressure of the cleaning liquid. Note that the signal outputted from the operated-degree detecting circuit 162 is transmitted to the main body 1 by a wire and is inputted to the control circuit 63. For example, the signal outputted from the operated-degree detecting circuit 162 is transmitted to the main body 1 via a signal cable embedded in a cover of the hose 3 for connecting the main body 1 and the cleaning gun 2 to each other or via a signal cable separated from the hose 3, and is inputted to the control circuit 63.

As described above, in the cleaning machine according to the present embodiment, the trigger lever 6 provided in the cleaning gun 2 is the operating part that changes the rotating speed of the electric motor 31 so as to increase/decrease the discharging pressure of the cleaning liquid.

Also in the cleaning machine according to the present embodiment, the rotating speed of the electric motor 31 is controlled in at least two control modes including the normal mode and the electricity saving mode. Moreover, the discharging pressure of the cleaning liquid in accordance with the increase/decrease in the operated degree (stroke degree) of the trigger lever 6 is increased/decreased within the range equal to or lower than the largest discharging pressure in the control mode at that time. Further, when the signal outputted from the battery-voltage detecting circuit 61 in the normal mode is inputted to the control circuit 63, the control mode of the electric motor 31 is automatically switched from the normal mode to the electricity saving mode.

That is, also in the cleaning machine according to the present embodiment, the control mode of the electric motor 31 is automatically switched from the normal mode to the electricity saving mode before the voltage of the battery pack 40 reaches the discharge stopping voltage. In other words, the largest discharging pressure of the cleaning liquid is automatically limited before the voltage of the battery pack 40 reaches the discharge stopping voltage, and therefore, the operating time can be extended.

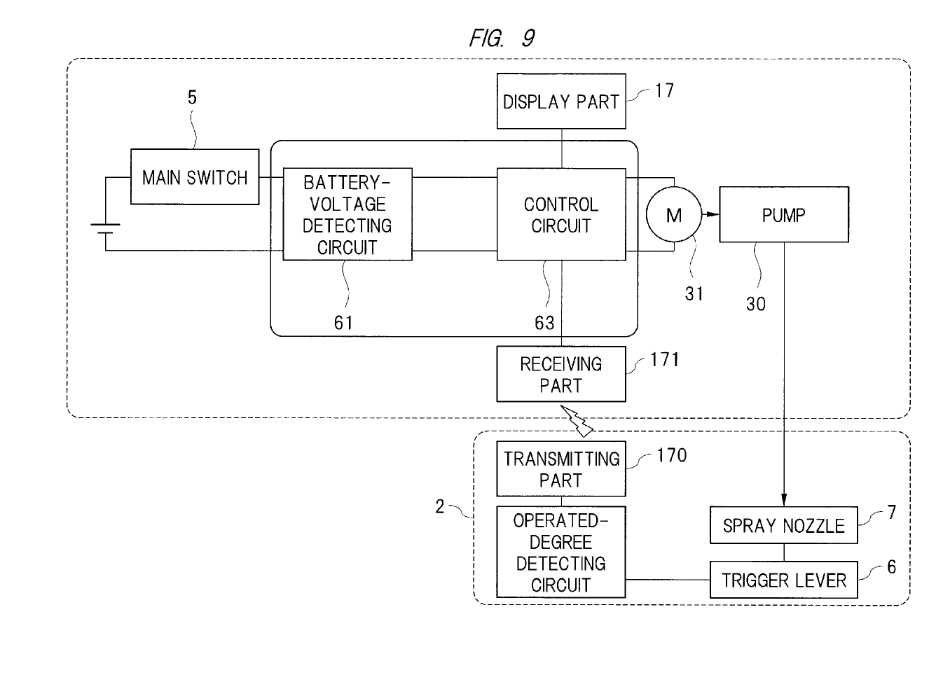

The signal outputted from the operated-degree detecting circuit 162 illustrated in FIG. 8 may be wirelessly transmitted to the main body 1. In the embodiment illustrated in FIG. 9, the cleaning gun 2 is provided with a transmitting part 170, and the main body 1 is provided with a receiving part 171. The transmitting part 170 transmits the signal outputted from the operated-degree detecting circuit 162. The receiving part 171 receives the signal transmitted from the transmitting part 170 and outputs the signal to the control circuit 63.

### Third Embodiment

In the above-described embodiments, the over-discharge preventing circuit which stops the discharge of the battery pack 40 is provided at the battery pack 40. However, in the present embodiment, the over-discharge preventing circuit is provided at the main body 1. More specifically, separately from the battery-voltage detecting circuit 61 illustrated in FIG. 5, a second battery-voltage detecting circuit which outputs a signal to the control circuit 63 when the voltage of the battery pack 40 is equal to or lower than the discharge stopping voltage is provided at the main body 1. In the present embodiment, when the signal outputted from the second battery-voltage detecting circuit is inputted to the control circuit 63, the control circuit 63 stops electric power supply from the battery pack 40 to the electric motor 31.

### Fourth Embodiment

In the present embodiment, after the voltage of the battery pack 40 is decreased down to the predetermined second voltage higher than the predetermined first voltage at which the electric power supply to the electric motor 31 is stopped, the largest discharging pressure of the cleaning liquid is gradually or continuously decreased. More specifically, a second electricity saving mode in which the largest discharging pressure is set to be lower than that of the above-described electricity saving mode (first electricity saving mode) and a third electricity saving mode in which the largest discharging pressure is set to be further lower than that of the second electricity saving mode are prepared. Moreover, a second mode switching voltage lower than the above-described mode switching voltage (first mode switching voltage) and a third mode switching voltage further lower than the second mode switching voltage are set. In the present embodiment, when the voltage of the battery pack 40 is decreased down to the first mode switching voltage, the control mode of the electric motor 31 is switched from the normal mode to the first electricity saving mode. Then, when the voltage of the battery pack 40 is decreased down to the second mode switching voltage, the control mode of the electric motor 31 is switched from the first electricity saving mode to the second electricity saving mode. Further, when the voltage of the battery pack 40 is decreased down to the third mode switching voltage, the control mode of the electric motor 31 is switched from the second electricity saving mode to the third electricity saving mode.

### Fifth Embodiment

In the above-described embodiments, the largest discharging pressure is previously set also for the normal mode. However, in the present embodiment, the largest discharging pressure is not set for the normal mode. More specifically, in the normal mode, there is no particular limitation for the applied voltage to the electric motor 31.

### Sixth Embodiment

In the above-described embodiments, the normal mode is set as the initially-set control mode. That is, when the electric power source is turned ON, the control of the electric motor 31 is started always in the normal mode regardless of the type of the battery pack 40 or others. However, the battery pack 40 of a different type is sometimes selectively used. For example, the battery pack 40 having a different discharged capacity is sometimes selectively used. In such a case, it is preferred to determine the type of the battery and select an appropriate control mode based on the determination result before the control of the electric motor 31 is started, that is, before the electric motor 31 is activated.

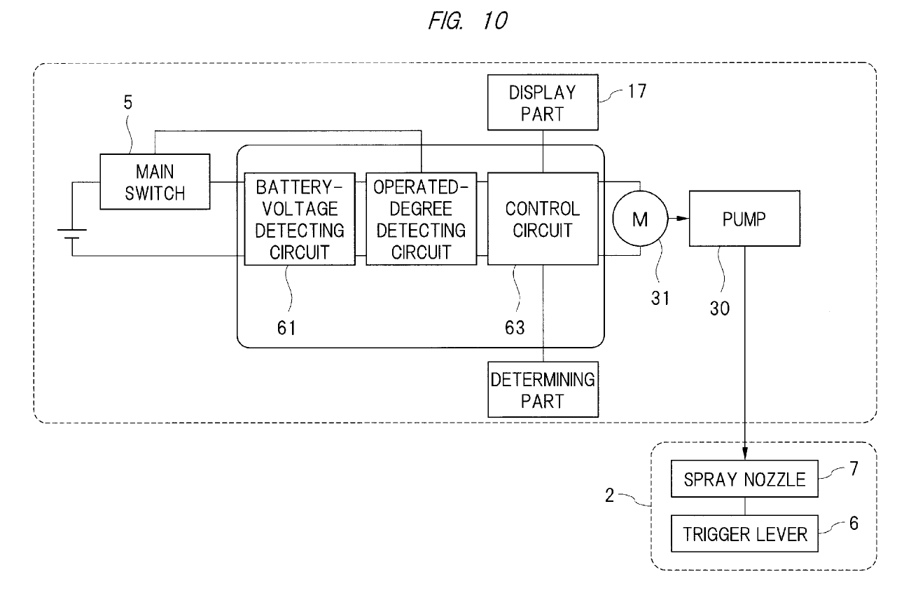

As illustrated in FIG. 10, the present embodiment has a determining part 180 provided so as to determine whether the battery pack 40 is mounted or not, determine the type of the mounted battery pack 40, and output the determination result to the control circuit 63. The illustrated determining part 180 determines the type of the battery pack 40 based on an identification element previously provided on the battery pack 40. Note that a resistance value that is different depending on the type (such as the discharged capacity and the battery voltage) of the battery pack 40 is set on the identification element, and the type of the battery pack 40 is determined based on the resistance value.

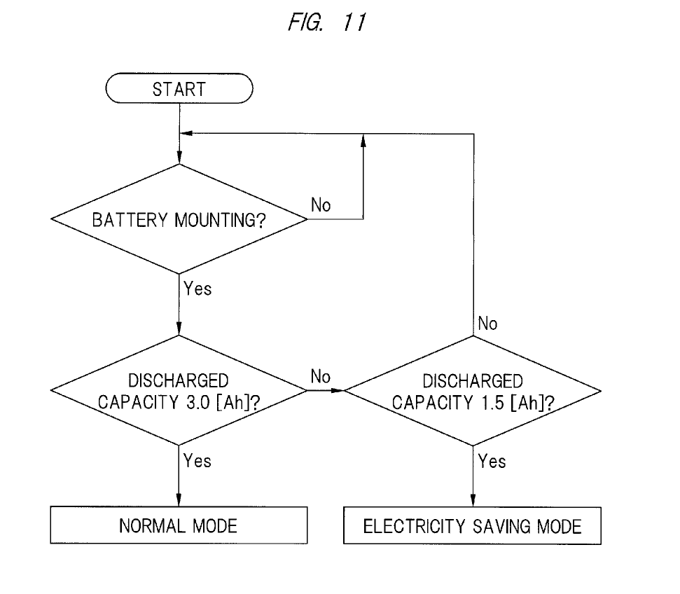

In the present embodiment, as illustrated in FIG. 11, it is determined first whether the battery pack 40 has been mounted or not. More specifically, when the resistance value of the identification element is read by the determining part 180 (FIG. 10), it is determined that the battery pack 40 has been mounted. When the resistance value is not read, it is determined that the battery pack 40 has not been mounted. When it is determined that the battery pack 40 has been mounted, the type of the battery pack 40 is subsequently determined. In the present embodiment, it is determined either that the discharged capacity of the battery pack 40 is 3.0 [Ah] or 1.5 [Ah]. Then, when it is determined that the discharged capacity of the mounted battery pack 40 is 3.0 [Ah], the control of the electric motor 31 is started in the normal mode. On the other hand, when it is determined that the discharged capacity of the mounted battery pack 40 is 1.5 [Ah], the control of the electric motor 31 is started in the electricity saving mode. That is, the control mode upon the activation of the electric motor 31 is selected in accordance with the type of the battery pack 40 determined by the determining part 180 illustrated in FIG. 10. Note that, after the control of the electric motor 31 is started in the normal mode, the control is performed by the steps similar to the step S1 and the following steps illustrated in FIG. 6. On the other hand, after the control of the electric motor 31 is started in the electricity saving mode, the control is performed by the steps similar to the step S3 and the following steps illustrated in FIG. 6.

Here, the aspect in which the control mode is selected based on the discharged capacity of the battery pack 40 has been explained. However, the control mode may be selected based on an element other than the discharged capacity, and the control mode may be selected based on, for example, the battery voltage.

### Seventh Embodiment

In the present embodiment, the normal mode in which the cleaning liquid is discharged by a constant predetermined pressure and an electricity saving mode in which the discharging pressure is changed in accordance with the battery voltage can be appropriately selected. The normal mode can be selected when the operation is desired always with the largest discharging pressure regardless of operating time, and the electricity saving mode can be selected when the operation is desired so that operating time is extended. For example, the mode is switched every time the push button 18 illustrated in FIG. 1 is pushed. Moreover, the selected control mode is displayed by the LED 17. When the push button 18 is pushed once after the electric power source is turned ON by rotating the main switch 5, the normal mode is selected. At this time, the LED 17 is lit with the red color to display the selection of the normal mode. When the trigger lever 6 is operated in this state, the cleaning liquid is discharged by the largest discharging pressure of 8.0 [MPa]. Note that, if the main body 1 or the cleaning gun 2 is provided with the operated-degree detecting circuit 62 or 162, the largest discharging pressure in the normal mode can be appropriately changed.

On the other hand, when the push button 18 is pushed twice, the electricity saving mode is selected. At this time, the LED 17 blinks on and off with a blue color to display the selection of the electricity saving mode. When the trigger lever 6 is operated in this state, the cleaning liquid is discharged by the largest discharging pressure of 8.0 [MPa] if the battery voltage (battery capacity) is high. However, as the battery voltage is lower, the discharging pressure is lower in accordance with the battery voltage. That is, if the battery voltage is decreased down to the second voltage or lower, the largest discharging pressure is decreased down to 5.0 [MPa], so that the operating time is extended.

In the present embodiment, the determination of whether the push button 18 has been pushed or not corresponds to the determination of whether the battery has been mounted or not as illustrated in FIG. 11. Also, the determination of the number of times of the pushing of the push button 18 corresponds to the determination of the battery capacity. More specifically, the normal mode is selected if the number of times of the pushing of the push button 18 is an odd number, and the electricity saving mode is selected if the number is an even number. If the normal mode is selected, the cleaning liquid is discharged by a predetermined constant pressure. On the other hand, if the electricity saving mode is selected, the steps S1 to S4 of FIG. 6 are executed. Note that, if the electricity saving mode is selected, only the steps S3 and S4 of FIG. 6 may be executed.

### Eighth Embodiment

In the present embodiment, a high-pressure mode in which the largest discharging pressure of the cleaning liquid is set to be relatively high and a low-pressure mode in which the largest discharging pressure is set to be relatively low can be appropriately selected. For example, the largest discharging pressure of the high-pressure mode is set to 8.0 [MPa], and the largest discharging pressure of the low-pressure mode is set to 1.0 [MPa] (equivalent to a water-tap pressure). As similar to the seventh embodiment, the mode switching can be performed by the number of times of operation of the push button 18. In the present embodiment, only when the high-pressure mode is selected, the discharging pressure is changed in accordance with the battery voltage. When the high-pressure mode is selected, the discharging pressure of the cleaning liquid is high, and therefore, the battery is fast to be consumed, and the operating time is shortened. Accordingly, in the case that the high-pressure mode is selected, when the battery voltage is decreased down to the second voltage, the discharging pressure is decreased from a current-state discharging pressure so as to extend the operating time. Note that when the low-pressure mode is selected, the discharging pressure of the cleaning liquid is low, and therefore, the battery is slow to be consumed, so that sufficient operating time is secured even when the discharging pressure is not controlled.

In the present embodiment, the determination of whether the push button 18 has been pushed or not corresponds to the determination of whether the battery has been mounted or not as illustrated in FIG. 11. Moreover, the determination of the number of times of the pushing of the push button 18 corresponds to the determination of the battery capacity. More specifically, the high-pressure mode is selected if the number of times of the pushing of the push button 18 is an odd number, and the low-pressure mode is selected if the number is an even number. If the high-pressure mode is selected, the steps S2 to S4 of FIG. 6 are executed. If the low-pressure mode is selected, the cleaning liquid is discharged by the set constant discharging pressure. Moreover, by selecting the low-pressure mode is selected, the machine can be used also for cleaning of an animal, an air conditioner, etc., so that the purpose of usage is expanded.

As described above, if the operator can appropriately select the operation mode, the discharging pressure and the operating time in accordance with the purpose of usage can be obtained, so that the cleaning machine having good workability can be provided.

The electric power source in the above-described embodiments is a secondary battery. However, characteristics of rapid decrease in the voltage at a point of a certain discharged capacity are not characteristics limited to the secondary battery but are characteristics common to many batteries including a primary battery. The present invention can be applied also to a cleaning machine which uses the primary battery as the electric power source.

### Ninth Embodiment

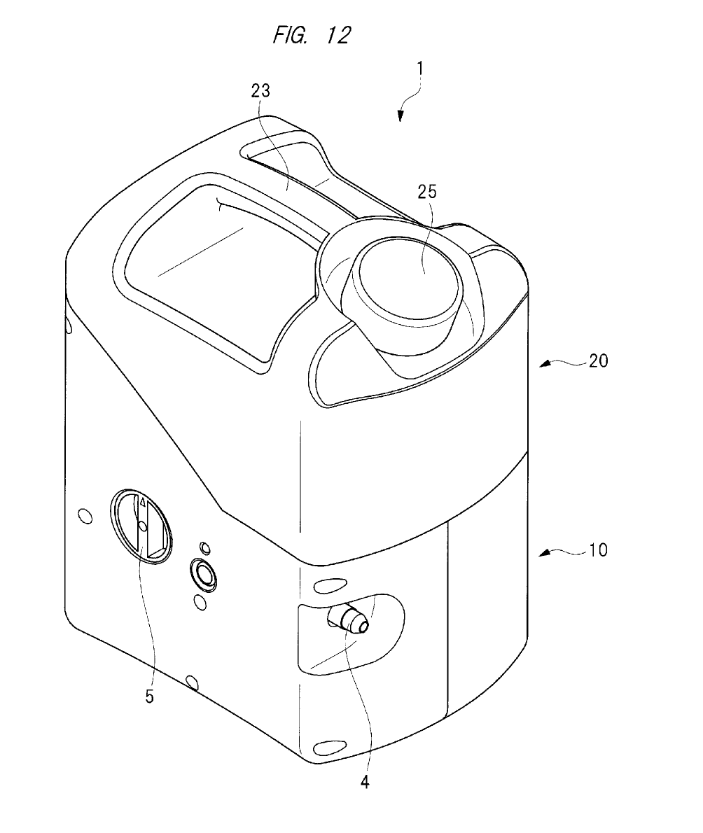

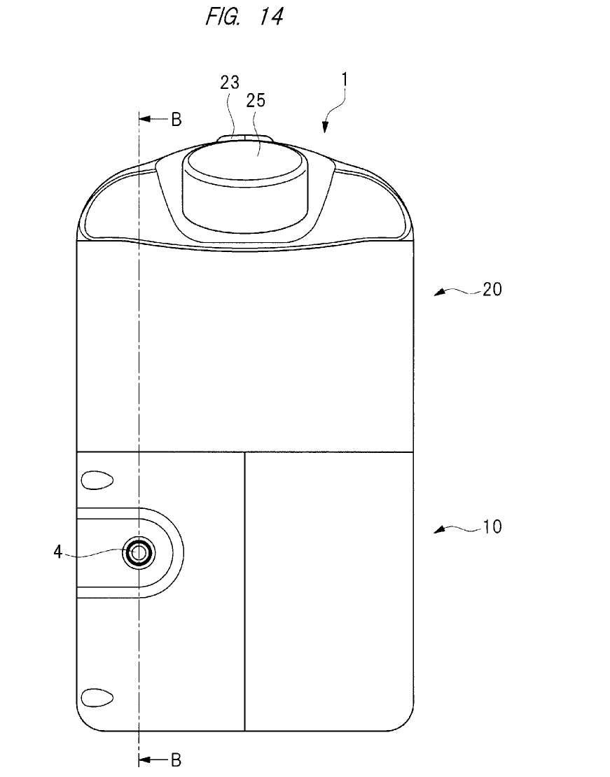

A cleaning machine according to the present embodiment has the main body 1 illustrated in FIGS. 12 to 14 and the cleaning gun 2 illustrated in FIG. 4. The main body 1 and the cleaning gun 2 are connected to each other via the hose 3 illustrated in FIG. 4. More specifically, one end of the hose 3 is fixed to the cleaning gun 2, and the not-illustrated other end of the hose 3 is connected to the connection plug 4 (in FIGS. 1 and 3) provided on the main body 1.

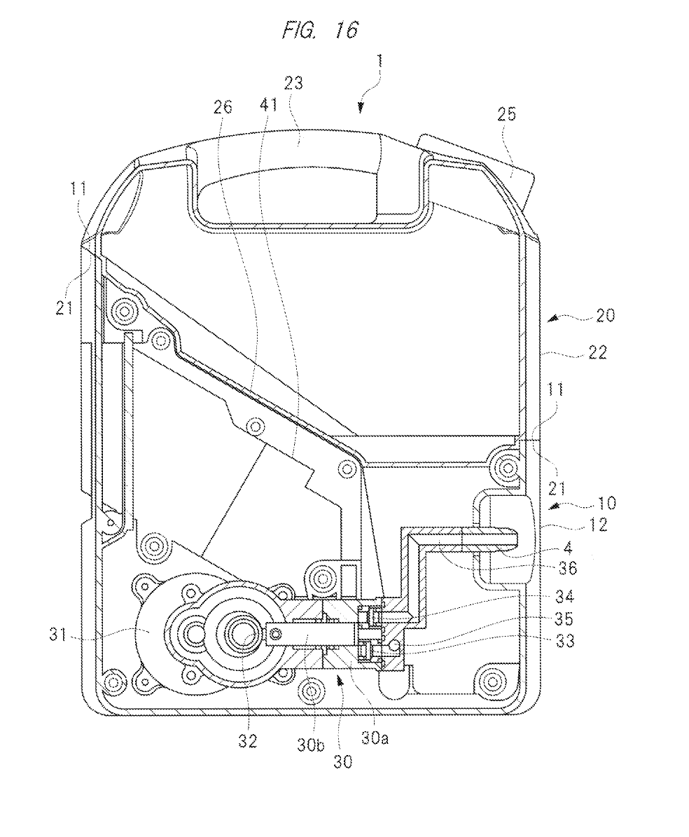

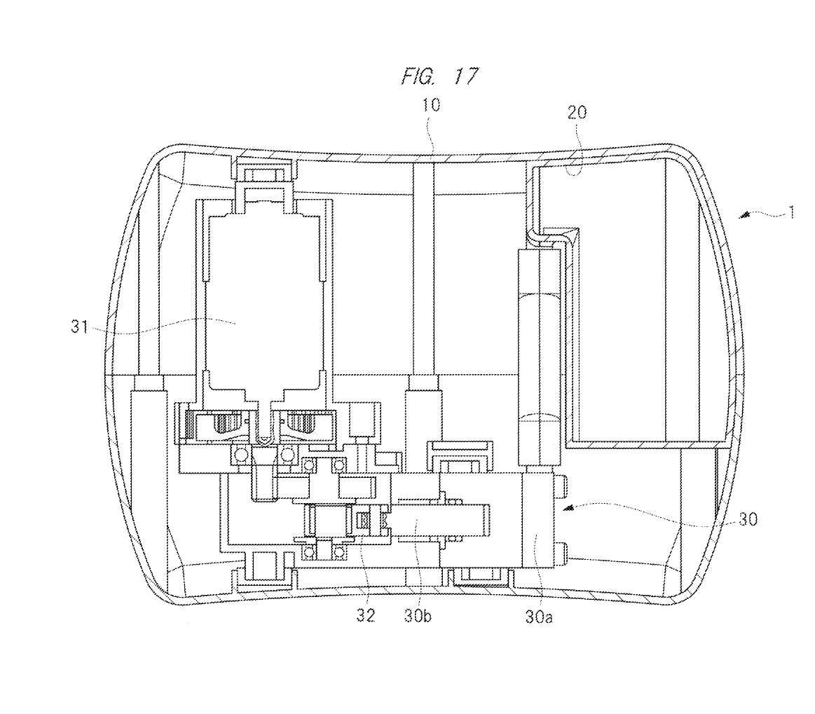

As illustrated in FIG. 16, the main body 1 is roughly separated into a base part 10 which forms the lower part thereof, and the tank 20 which forms the upper part thereof. As illustrated in FIGS. 16 and 17, a drive part including the pump 30 and the electric motor 31 is housed inside the base part 10.

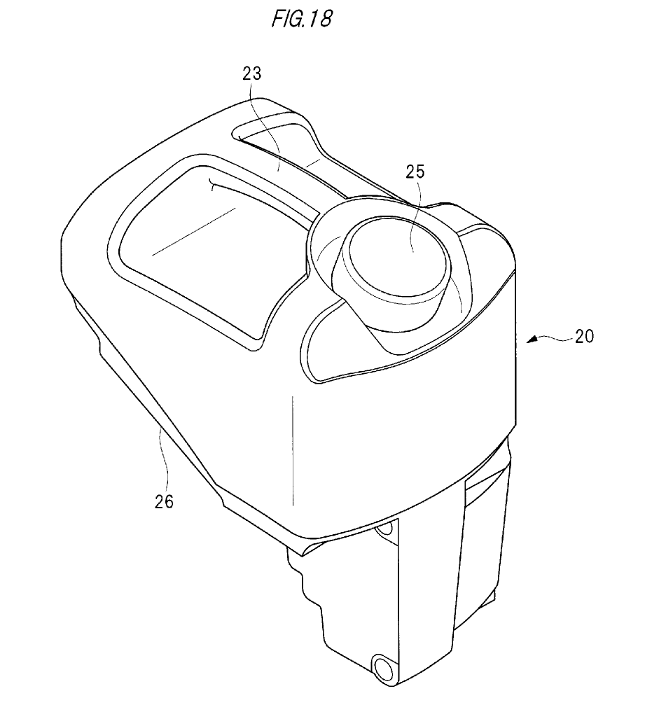

On the other hand, the tank 20 has a shape illustrated in FIG. 18. As illustrated in FIG. 16, the tank 20 is arranged to be overlapped on the base part 10 and is integrated with the base part 10. More specifically, a bottom peripheral edge 21 of the tank 20 fitted inside the base part 10 is overlapped with an opening end surface 11 of the base part 10. Outer peripheral surfaces 12 and 22 of the respective base part 10 and tank 20 vertically overlapped with each other are on a single plane, and form outer peripheral surfaces (front surface, back surface, and both side surfaces) of the main body 1 as a whole.

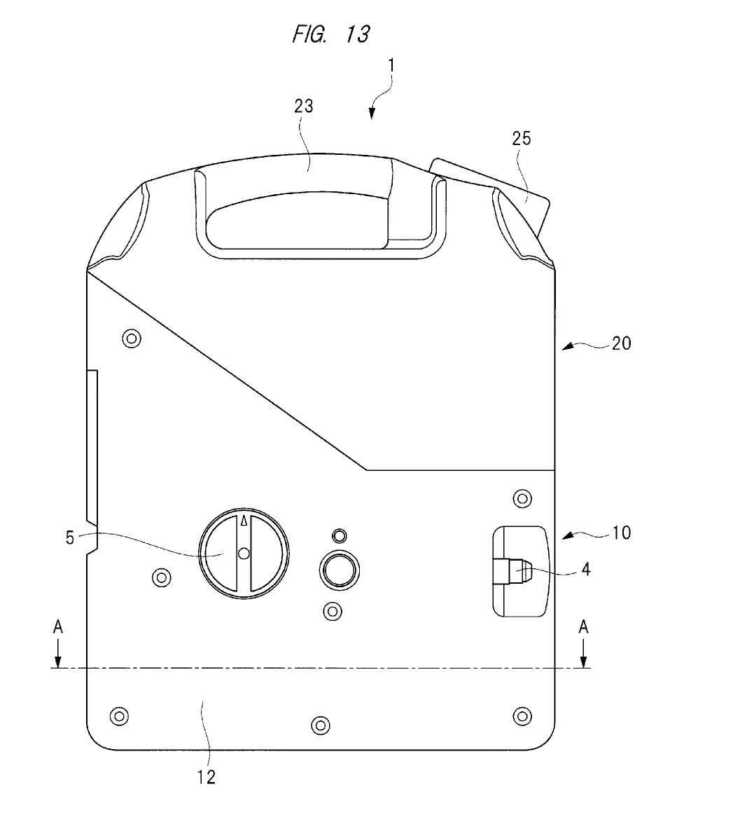

As illustrated in FIGS. 12 and 13, the main switch 5 serving as an operating part is provided on one of the side surfaces of the main body 1. The main switch 5 is a dial type, and the electric power source of the cleaning machine is turned ON/OFF by a rotating operation of the main switch 5. In the present embodiment, the electric power source is turned ON by rotating the main switch 5 clockwise by a predetermined angle from an initial position so that the electric motor 31 (in FIGS. 16 and 17) is activated, and the electric power source is turned OFF by rotating the main switch 5 counterclockwise to return to the initial position so that the electric motor 31 is stopped.

Further, after the electric power source is turned ON, the rotating speed of the electric motor 31 is increased/decreased in accordance with the operated degree of the main switch 5 (in accordance with the rotation angle from the initial position). More specifically, the rotating speed of the electric motor 31 is increased by the increase in the rotation angle of the main switch 5 is increased, and the rotating speed of the electric motor 31 is decreased by the decrease in the rotation angle thereof. That is, the main switch 5 functions as an operating part which changes the rotating speed of the electric motor 31 so as to increase/decrease the discharging pressure of the cleaning liquid.

As illustrated in FIGS. 16 and 17, the pump 30 and the electric motor 31 (drive part) are arranged in a lower part of the base part 10. That is, the pump 30 and the electric motor 31 are arranged in the lower part of the main body 1. The pump 30 has the cylinder 30a and the plunger 30b which is housed inside the cylinder 30a so as to reciprocate, and the rotary motion of the electric motor 31 is converted into reciprocating motion by the crankshaft 32, and is transmitted to the plunger 30b. That is, the pump 30 is an electric pump which is driven by the electric motor 31.

As illustrated in FIG. 16, the cylinder 30a of the pump 30 is provided with a flow inlet into which the cleaning liquid flows and a flow outlet from which the cleaning liquid flows out, and the flow inlet and the flow outlet are provided with one-way valves 33 and 34, respectively. Also, inside the main body 1, a flow channel 35 which communicates between an outlet (supply port) provided at a bottom part of the tank 20 and the flow inlet of the cylinder 30a is provided. Moreover, inside the main body 1, a flow channel 36 which communicates between the flow outlet of the cylinder 30a and the connection plug 4 provided on the front surface of the main body 1 is provided. The cleaning liquid guided to the flow inlet via the flow channel 35 flows into the cylinder 30a via the one-way valve 33, and is compressed (pressurized) by the plunger 30b which repeats the reciprocating motion inside the cylinder 30a. The pressurized cleaning liquid flows out from the cylinder 30a via the one-way valve 34, and is fed to the connection plug 4 via the flow channel 36. The cleaning liquid fed to the connection plug 4 is fed to the cleaning gun 2 (FIG. 4) via the hose 3 (FIG. 2) connected to the connection plug 4. When the trigger lever 6 of the cleaning gun 2 is operated (pulled), the cleaning liquid fed to the cleaning gun 2 is sprayed from the spray nozzle 7 provided at the tip of the cleaning gun 2.

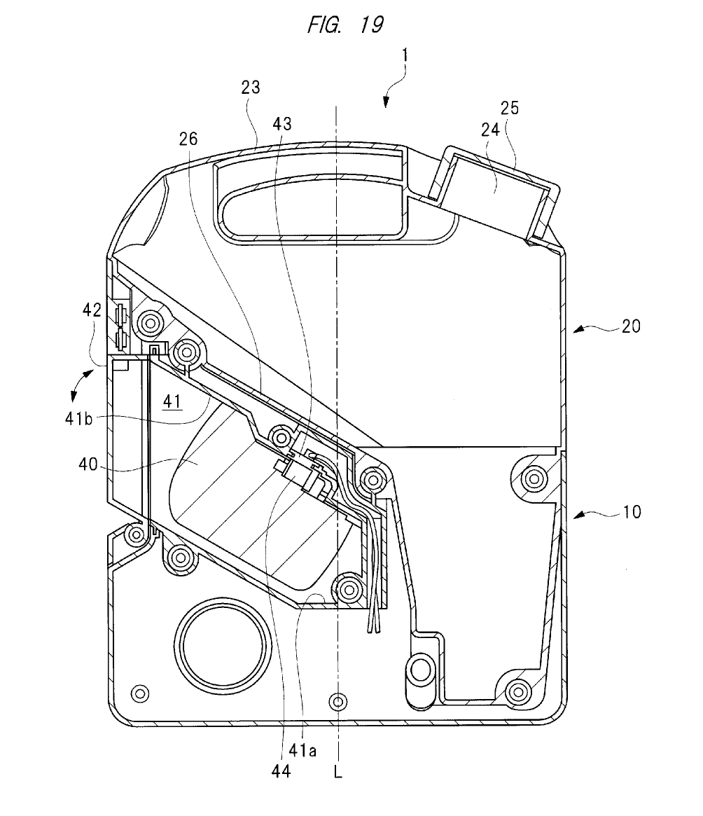

As illustrated in FIGS. 12 and 18 etc., the handle 23 is integrally molded with the upper part of the tank 20. Moreover, as illustrated in FIG. 19, a flow inlet (feed-water inlet 24) communicated with the inside of the tank 20 is also integrally molded with the upper part of the tank 20. When the cleaning liquid is supplied from the feed-water inlet 24 into the tank 20 or when the cleaning liquid inside the tank 20 is drained from the feed-water inlet 24, the cap 25 is removed from the main body 1 (tank 20) to open the feed-water inlet 24. The illustrated cap 25 is a screw-in type, and the cap is rotated counterclockwise so as to be removed from the main body 1 (tank 20) and is rotated clockwise so as to be fixed to the main body 1 (tank 20). The feed-water inlet 24 is arranged on an opposite side of the battery 40 across a virtual line L which is extended in an up-to-down direction of the main body 1 and which passes through a center of the main body 1 in a right-to-left direction. This arrangement is to avoid the spill out of the cleaning liquid on the battery 40 when the cleaning liquid is supplied from the feed-water inlet 24. As a matter of course, since the battery 40 is hermetically sealed by the battery housing part 41 and the cover member 42, the cleaning liquid is not spilled on the battery 40 even if the cleaning liquid is spilled out.

As illustrated in FIG. 16, a tilted part 26 is provided on the bottom surface of the tank 20. The tilted part 26 is tilted downward from the back surface of the tank 20 toward the flow outlet (supply port) at the bottom part of the tank 20. In other words, the tilted part 26 has a downward slope toward the flow outlet. Note that the flow outlet of the tank 20 is communicated with the flow inlet of the pump 30 (cylinder 30a) via the flow channel 35 as already described above.

Since the tilted part 26 is provided on the bottom surface of the tank 20 which is arranged to be overlapped and on the base part 10, a space is formed between the base part 10 and the tank 20, and the battery housing part 41 is provided by utilizing this space. More specifically, as illustrated in FIG. 16, the battery housing part 41 is provided above the pump 30 and the electric motor 31 inside the base part 10. In other words, the battery housing part 41 is provided between the pump 30, the electric motor 31 and the tank 20. More specifically, the battery housing part 41 is provided between the pump 30, the electric motor 31 and the tilted part 26 of the tank 20.

As illustrated in FIG. 19, the battery 40 serving as the electric power source of the electric motor 31 (FIG. 16) is housed in the battery housing part 41. The battery housing part 41 is tilted along the tilted part 26 of the tank 20, and the battery 40 is obliquely taken in/out along the slope of the battery housing part 41. More specifically, a bottom surface 41a and a ceiling surface 41b of the battery housing part 41 are tilted along the tilted part 26 of the tank 20.

On the back surface of the main body 1 (base part 10), the cover member 42 which opens/closes the battery housing part 41 is provided so as to be rotatable in a direction of an arrow in the drawing. By rotating the cover member 42 so as to open the battery housing part 41, the battery 40 can be housed in the battery housing part 41 or the housed battery 40 can be taken out from the battery housing part 41. An electrode (a main-body-side electrode 43) is provided on the ceiling surface 41b of the battery housing part 41. By housing the battery 40 in the battery housing part 41, an electrode (a battery-side electrode 44) provided on the battery 40 is in contact with the main-body-side electrode 43 so as to secure electric conduction. The cover member 42 is provided with a seal member which seals the battery housing part 41. The seal member is made of an elastic body such as rubber, and prevents entering of water or others from outside into the battery housing part 41 when the cover member 42 closes the battery housing part 41.

The battery 40 according to the present embodiment is a battery pack (secondary battery (lithium-ion battery)) configured of four serially-connected battery cells, and has a nominal voltage of 14.4 [V]. Moreover, the battery pack 40 is provided with an over-discharge preventing circuit which stops discharge when the voltage is decreased down to a predetermined first voltage (hereinafter, referred to as “discharge stopping voltage”). In the present embodiment, the discharge stopping voltage is set to 8.0 [V], and therefore, the discharge of the battery pack 40 is stopped by the over-discharge preventing circuit when the voltage of the battery pack 40 is decreased down to 8.0 [V]. As a matter of course, the battery 40 is not limited to the lithium-ion battery nor to the secondary battery. The battery 40 may be, for example, a manganese battery, a nickel-hydride battery, a nickel-cadmium battery, or others.

As described above, the cleaning machine according to the present embodiment uses the battery 40 as the electric power source and is provided with the tank 20 which stores the cleaning liquid, and therefore, the cleaning machine can be used even at a location where a commercial electric power source cannot be secured and at a location to which a faucet of tap water is not close. That is, the limitation of the location where the cleaning machine is used is relaxes. Moreover, in the cleaning machine according to the present embodiment, the space is secured between the base part 10 and the tank 20 by providing the tilted part 26 on the bottom surface of the tank 20 which is arranged to be overlapped on the base part 10, and the battery housing part 41 is provided by utilizing this space. Therefore, increase in the size of the cleaning machine caused by providing the battery housing part 41 and the tank 20 is suppressed as much as possible. More particularly, increase in the size of the cleaning machine in a lateral direction is avoided, so that the cleaning machine can be installed in a small space and can be easily carried. Further, since the tilted part 26 of the tank 20 is tilted downward toward the outlet of the tank 20, the cleaning liquid inside the tank 20 is guided to the outlet of the tank 20 without tilting the main body 1 (tank 20). Moreover, when the bottom surface of the tank 20 is flat, if the main body 1 is tilted, the cleaning liquid remains at a corner of the bottom surface of the tank 20, and therefore, it is difficult to use all of the cleaning liquid. In the present embodiment, since the tilted part 26 is provided on the bottom surface of the tank 20, the cleaning liquid is always collected to the flow outlet of the tank 20. Therefore, all of the cleaning liquid can be used without waste. Further, the flow outlet of the tank 20 is arranged above the pump 30 and the electric motor 31 while on a side of the battery housing part 41, and therefore, a weight of the whole cleaning machine is balanced well even in a state that an amount of the cleaning liquid is small, so that the cleaning machine can be easily carried.

In addition, the battery 40 which has a relatively heavy weight is arranged in the lower part of the main body 1 or in the vicinity thereof, and therefore, the main body 1 is stabilized. Moreover, the pump 30 and the electric motor 31 are arranged in the lower part of the main body 1, and therefore, the heavy objects are gathered in the lower part of the main body 1 so as to be stabilized. The drive part (the pump 30 and the electric motor 31) which is the heavy object is arranged in the lower side of the main body 1, and therefore, good weight balance is obtained. A dimension of the main body 1 in a width direction (lateral direction) is small, and therefore, it is difficult that the main body 1 is in contact with a body of the operator when the machine is used so as to be hung from a shoulder of the operator or others. Even when the main body 1 is placed on a working table for resupplying the cleaning liquid, the main body 1 is stabilized and does not easily fall down.

The battery housing part 41 is obliquely tilted, and therefore, the taking in/out directions of the battery 40 and the battery housing part 41 are substantially parallel to each other, so that it is easy to perform a replacing operation of the battery 40.

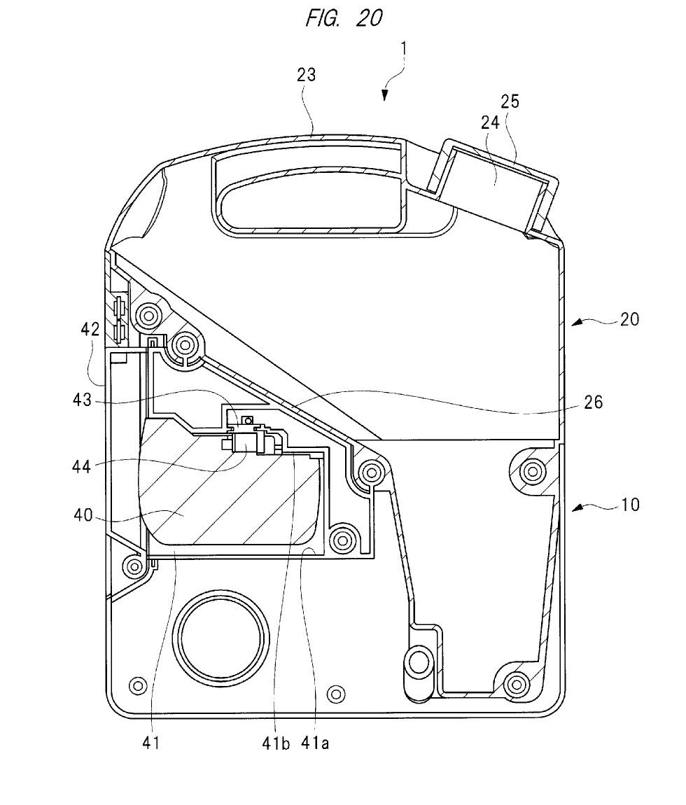

FIGS. 20 to 22 illustrate different modification examples of the cleaning machine according to the present embodiment, respectively. The battery housing part 41 in the cleaning machine according to the present embodiment is tilted along the tilted part 26 of the tank 20 (see FIG. 19). However, the battery housing part 41 in the cleaning machine illustrated in FIG. 20 is not tilted. More specifically, the ceiling surface 41b of the battery housing part 41 illustrated in FIG. 20 is parallel or horizontal as a whole, and the bottom surface 41a thereof is parallel. The illustrated battery 40 is taken in/out in a parallel direction.

As a matter of course, the arrangement of the battery housing part 41 in the cleaning machine illustrated in FIG. 20 is the same as the arrangement of the battery housing part 41 in the cleaning machine according to the present embodiment. That is, also in the cleaning machine illustrated in FIG. 20, the space is secured between the base part 10 and the tank 20 by providing the tilted part 26 on the bottom surface of the tank 20 which is arranged to be overlapped on the base part 10, and the battery housing part 41 is provided by utilizing this space. Therefore, the cleaning machine illustrated in FIG. 20 also exerts working effects as similar to those described above.

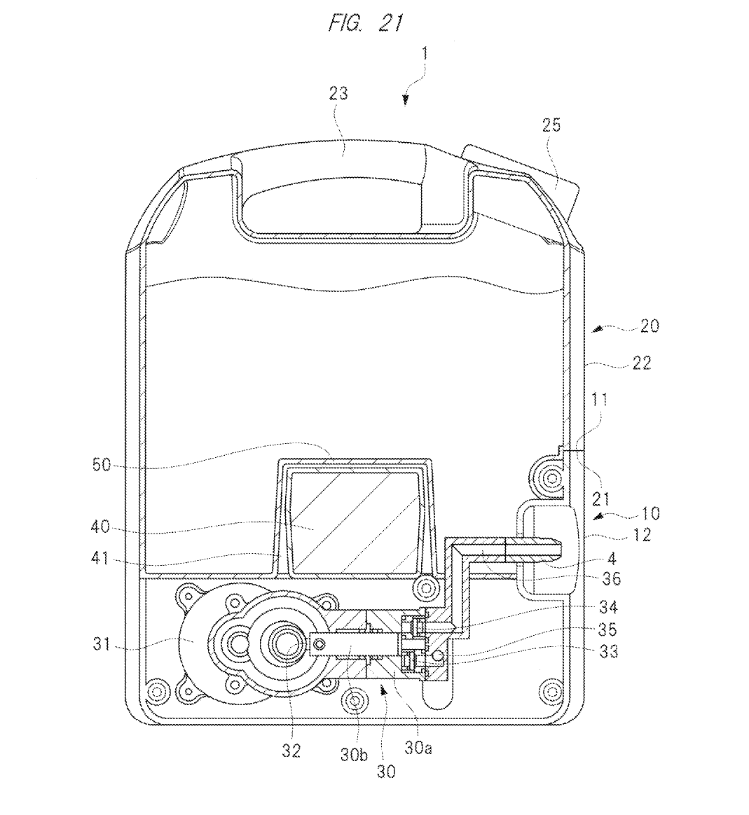

In a cleaning machine illustrated in FIG. 21, a concave part 50 concaved toward an inner side of the tank 20 is provided in the lower part of the tank 20. More specifically, the concave part 50 is provided from a center of the side surface to a center of the bottom surface of the tank 20, and the battery housing part 41 is provided inside the concave part 50. That is, in the cleaning machine according to the present embodiment, the space is secured between the base part 10 and the tank 20 by providing the tilted part 26 on the bottom surface of the tank 20. On the other hand, in the cleaning machine illustrated in FIG. 21, the space is secured between the base part 10 and the tank 20 by providing the concave part 50 on the bottom part of the tank 20. As a matter of course, the cleaning machine illustrated in FIG. 21 is common to the cleaning machine according to the present embodiment in a point that the space for providing the battery housing part 41 is secured by devising the shape of the tank, and is not different therefrom in essential characteristics. Further, in the cleaning machine illustrated in FIG. 21, the battery housing part 41 is provided inside the concave part 50 provided at the center of the bottom part of the tank 20, and therefore, the battery 40 having the relatively heavy weight is arranged at a position closer to the center of the main body 1. Therefore, the stability of the main body 1 is further improved. More particularly, the stability of the main body 1 obtained when the amount of the cleaning liquid inside the tank 20 is reduced is improved.

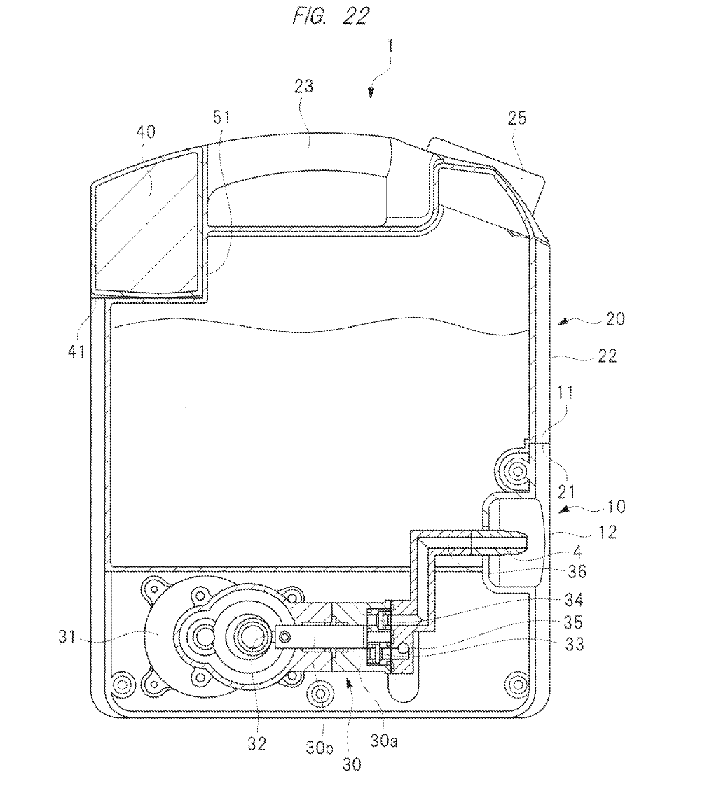

In a cleaning machine illustrated in FIG. 22, a concave part 51 which is concaved toward the inner side of the tank 20 is provided in the upper part of the tank 20. More specifically, the concave part 51 is provided from a center of an upper surface of the tank 20 to a center of a back surface thereof, and the battery housing part 41 is provided inside the concave part 51. As a matter of course, the cleaning machine illustrated in FIG. 22 is common to the cleaning machine according to the present embodiment in a point that the space for providing the battery housing part 41 is secured by devising the shape of the tank, and is not different therefrom in essential characteristics. Further, in the cleaning machine illustrated in FIG. 22, the battery housing part 41 is provided inside the concave part 51 provided in the upper part of the tank 20, and therefore, the battery 40 is arranged at a high position of the main body 1. Therefore, a replacing operation of the battery 40 becomes easy. More particularly, the replacing operation of the battery becomes easy when the main body 1 is placed at a low position such as ground and others.

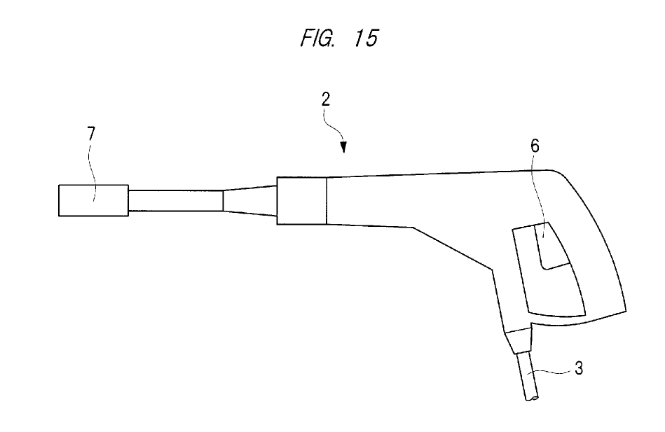

The present invention is not limited to the above-described embodiments, and various modifications can be made within a scope of the invention. For example, in the above-described embodiments and modifications examples thereof, the discharging pressure of the cleaning liquid is changed in accordance with the operated degree of the main switch 5 (FIG. 12) provided on the main body 1. However, there is an embodiment in which the discharging pressure of the cleaning liquid is changed in accordance with an operated degree of the trigger lever 6 (FIG. 15) provided on the cleaning gun 2.

1-33. (canceled)

34. A cleaning machine provided with a main body which discharges cleaning liquid by a pump and a cleaning gun which is connected to the main body,
the cleaning machine comprising:
an electric motor which receives electric power supply from a battery and which drives the pump; and
a control part which changes a rotating speed of the electric motor so as to increase/decrease a discharging pressure of the cleaning liquid, and
the largest discharging pressure of the cleaning liquid being decreased to be lower than a current-state discharging pressure thereof when a voltage of the battery is decreased down to a predetermined second voltage higher than a predetermined first voltage at which the electric power supply to the electric motor is stopped.

35. The cleaning machine according to claim 34,
wherein, when the voltage of the battery is decreased down to the second voltage, the rotating speed of the electric motor is decreased.

36. The cleaning machine according to claim 35,
wherein, when the voltage of the battery is decreased down to the second voltage, an applied voltage of the electric motor is decreased.

37. The cleaning machine according to claim 34,
wherein the electric motor is driven in at least two control modes including a normal mode and an electricity saving mode in which the largest discharging pressure of the cleaning liquid is set to be lower than the largest discharging pressure of the normal mode; and,
when the voltage of the battery is decreased to the second voltage in the normal mode, the control mode of the electric motor is switched from the normal mode to the electricity saving mode.

38. The cleaning machine according to claim 37,
wherein the largest discharging pressure of the cleaning liquid in the electricity saving mode is set to be equal to or lower than 80% of the largest discharging pressure of the cleaning liquid in the normal mode.

39. The cleaning machine according to claim 37,
wherein the cleaning machine has an operating part which is operated by an operator, and the rotating speed of the electric motor is changed in accordance an operated degree of the operating part, and the discharging pressure of the cleaning liquid is increased/decreased within a range equal to or lower than the largest discharging pressure of the cleaning liquid in each of the control modes.

40. The cleaning machine according to claim 39,
wherein the operating part is provided in the main body.

41. The cleaning machine according to claim 39,
wherein the operating part is provided in the cleaning gun.

42. The cleaning machine according to claim 37,
wherein the cleaning machine has a determining part which determines a type of the battery, and
the control mode for activating the electric motor is selected in accordance with the type of the battery determined by the determining part.

43. The cleaning machine according to claim 34,
wherein the battery is a secondary battery.

44. The cleaning machine according to claim 34,
wherein the cleaning machine has a display part which informs that the voltage of the battery is decreased down to the second voltage or lower.

45. The cleaning machine according to claim 34,
wherein the electric motor is stopped when the voltage of the battery reaches the first voltage.

46. A cleaning machine provided with a main body which discharges cleaning liquid by a pump and a cleaning gun which is connected to the main body,
the cleaning machine comprising:
an electric motor which receives electric power supply from a battery and which drives the pump; and
a control part which controls the electric motor, and
the electric motor being driven by at least two control modes including a normal mode in which the cleaning liquid is discharged by a predetermined discharging pressure and an electricity saving mode in which the discharging pressure of the cleaning liquid is changed based on the voltage of the battery.

47. The cleaning machine according to claim 46,
wherein the cleaning machine has mode switching means which switch the normal mode and the electricity saving mode.

48. The cleaning machine according to claim 46,
wherein the cleaning machine has pressure setting means which set the discharging pressure of the cleaning liquid, and,
in the normal mode, the cleaning liquid is discharged by the discharging pressure set by the pressure setting means.

49. A cleaning machine provided with a main body which discharges cleaning liquid by a pump and a cleaning gun which is connected to the main body,
the cleaning machine comprising:
an electric motor which receives electric power supply from a battery and which drives the pump; and
a control part which controls the electric motor, and
the cleaning liquid being able to discharged by at least two control modes including a high-pressure mode in which the cleaning liquid can be discharged by the first largest discharging pressure and a low-pressure mode in which the cleaning liquid can be discharged by the second largest discharging pressure lower than the first largest discharging pressure.

50. The cleaning machine according to claim 49,
wherein the cleaning machine has mode switching means which switch the high-pressure mode and the low-pressure mode.

51. The cleaning machine according to claim 49,
wherein the control part can change the discharging pressure of the cleaning liquid during when the high-pressure mode is set.

52. The cleaning machine according to claim 51,
wherein, when the voltage of the battery is decreased down to a predetermined second voltage higher than a predetermined first voltage at which the electricity power supply to the electric motor is stopped, the control part decreases the discharging pressure of the cleaning liquid to be lower than a current-state discharging pressure thereof.

53. A cleaning machine which discharges cleaning liquid comprising
a tank part which stores the cleaning liquid, a cleaning gun which sprays the cleaning liquid, and a drive part which is positioned below the tank part and feeds the cleaning liquid to the cleaning gun while using a battery as an electric power source, and
the battery being arranged above the drive part.

54. The cleaning machine according to claim 53,
wherein the battery is arranged between the drive part and the tank.

55. A cleaning machine which discharges cleaning liquid, comprising:
a main body provided with a tank which stores the cleaning liquid, a pump which feeds the cleaning liquid supplied from the tank, an electric motor which drives the pump, and a battery housing part which houses a battery serving as an electric power source of the electric motor; and
a cleaning gun which sprays the cleaning liquid supplied from the main body,
the pump and the electric motor being arranged in a lower part of the main body,
the tank being arranged in an upper part of the main body, and
the battery housing part being arranged between the pump, the electric motor and the tank.

56. The cleaning machine according to claim 55,
wherein a bottom surface of the tank is provided with a tilted part, and
the battery housing part is arranged between the pump, the electric motor and the tilted part of the tank.

57. The cleaning machine according to claim 56,
wherein the battery housing part is tilted along the tilted part of the tank, and
the battery is obliquely taken in/out to/from the main body.

58. The cleaning machine according to claim 56,
wherein the battery housing part is parallely arranged, and
the battery is taken in/out in a parallel direction of the main body.

59. The cleaning machine according to claim 56,
wherein a bottom part of the tank is provided with a supply port communicated with the pump, and
the tilted part of the tank is tilted downward toward the supply port.

60. The cleaning machine according to claim 59,
wherein the supply port is arranged above the pump and the electric motor while on a side of the battery housing part.

61. The cleaning machine according to claim 57,
wherein a tilted direction of the tilted part and a taking-in/out direction of the battery are substantially the same as each other.

62. A cleaning machine which discharges cleaning liquid, comprising:
a main body provided with a tank which stores the cleaning liquid, a pump which feeds the cleaning liquid supplied from the tank, an electric motor which drives the pump, and a battery housing part which houses a battery serving as an electric power source of the electric motor; and
a cleaning gun which sprays the cleaning liquid supplied from the main body,
the pump and the electric motor being arranged in a lower part of the main body,
the tank being arranged in an upper part of the main body, and
a concave part concaved toward an inside of the tank being provided in the tank, and the battery housing part being provided inside the concave part.

63. The cleaning machine according to claim 62,
wherein the concave part is provided in a lower part of the tank.

64. The cleaning machine according to claim 62,
wherein the concave part is provided in an upper part of the tank.

65. The cleaning machine according to claim 55,
wherein the tank has a feed-water inlet through which the cleaning liquid is poured from outside, and
the feed-water inlet is arranged on an opposite side of the battery housing part across a virtual line which passes through a center of the main body in a right-and-left direction and which is extended in an up-and-down direction.

66. The cleaning machine according to claim 55,
wherein the pump pressurizes the cleaning liquid supplied from the tank.
